(19) United States
(12) Patent Application Publication
(10) Pub. No.: US 2011/0305020 A1
(43) Pub. Date: Dec. 15, 2011

(54) LED LAMP AND HEAT-DISSIPATING ASSEMBLY THEREOF

(75) Inventor: Chin-Wen WANG, Pingzhen City (TW)

(73) Assignee: Chin-Wen WANG & LEADER TREND TECHNOLOGY CORP.

(21) Appl. No.: 12/797,356

(22) Filed: Jun. 9, 2010

(51) Int. Cl. F21S 4/00

(52) U.S. Cl. 362/249.02; 362/294

(57) ABSTRACT

A LED lamp having a heat-dissipating assembly includes a lamp seat and a LED module. The heat-dissipating assembly includes a metallic base, a vapor chamber, heat pipes, heat-dissipating fins sheathed on the heat pipes, and fixing elements. The metallic base has a first plate and a second plate overlapped with each other. The first plate and the second plate are provided with locking holes. The vapor chamber is brought into thermal contact with the first plate. The heat pipes penetrate between the first plate and the second plate. The lamp seat is provided with an opening and fixing holes corresponding to the locking holes. The fixing elements penetrate the fixing holes and the locking holes, thereby fixing the lamp seat to the metallic base. In this way, the fixation of the vapor chamber with other heat-dissipating body is simplified and the present invention can be assembled easily.

### BACKGROUND OF THE INVENTION

1. Field of the Invention

The present invention relates to a heat-dissipating device, in particular to a heat-dissipating assembly of a LED lamp.

2. Description of Prior Art

Generally speaking, the amount of waste heat generated by a light emitting diode (LED) is in proportional to its power. The waste heat has adverse impacts to life and light-emitting performance of the LED. Thus, LED lamps are always provided with a heat-dissipating assembly to immediately dissipate the waste heat to the outside.

With the development of high-power LED, the heat-dissipating efficiency of the existing heat-dissipating assembly is insufficient for the high-power LED, so that heat may be accumulated in the LED lamp. Therefore, it is necessary to provide a heat-dissipating assembly with a better heat-conducting efficiency. Currently, manufacturers in this art incorporate vapor chambers and heat pipes into a heat-dissipating device for the LED lamp, thereby rapidly conducting the waste heat of the LED. Such a solution is able to achieve a great heat-dissipating effect.

However, since a working fluid is filled and circulates in the vapor chamber and the heat is conducted by means of the vapor/liquid phase change of the working fluid, the interior of the vapor chamber may expand when it is hot and contract when it is cold. As a result, the impermeability of sealed edges of the vapor chamber is vey critical.

Conventionally, when the vapor chamber is connected to other heat-dissipating bodies (such as heat-dissipating fins), a fixing mechanism has to be provided on the vapor chamber. For example, a plurality of through-holes or tabs is provided on the edge of the vapor chamber, whereby the vapor chamber can be connected to the desired heat-dissipating bodies (such as heat-dissipating fins). However, providing the fixing mechanism on the vapor chamber may make the vapor chamber to suffer damage. Thus, the fixing mechanism has to be manufactured very carefully, which increases the working hours for manufacturing the vapor chamber. On the other hand, the profile of the vapor chamber may restrict the position of the fixing mechanism thereon, which also makes it inconvenient in use.

Therefore, in order to solve the above problems, the present Inventor proposes a novel and reasonable structure based on his research and expert knowledge.

### SUMMARY OF THE INVENTION

The present invention is to provide a LED lamp, in which a vapor chamber and heat pipes form a heat-dissipating assembly to conduct the heat of the LED lamp quickly.

The present invention provides a LED lamp including a metallic base, a vapor chamber, a plurality of heat pipes, a plurality of heat-dissipating fins, a lamp seat, a LED module, and a plurality of fixing elements. The metallic base has a first plate and a second plate overlapped with each other. The first plate and the second plate are provided with a plurality of locking holes corresponding to each other. The vapor chamber is brought into thermal contact with the first plate. The heat pipes penetrate between the first plate and the second plate. The heat-dissipating fins are sheathed on the heat pipes and parallel to each other. The lamp seat is provided with an opening and fixing holes corresponding to the locking holes. The LED module is positioned to correspond to the opening. The LED module comprises a circuit board abutting the vapor chamber and a plurality of LEDs arranged on one surface of the circuit board. The fixing elements penetrate the fixing holes and the locking holes to thereby fix the lamp seat to the first plate and the second plate.

The present invention further provides a heat-dissipating assembly of a LED lamp, in which the fixation of a vapor chamber and other heat-dissipating body is simplified to facilitate the assembly thereof.

The present invention provides a heat-dissipating assembly of a LED lamp. The LED lamp comprises a lamp seat having a plurality of fixing holes. The heat-dissipating assembly includes a metallic base, a vapor chamber, a plurality of heat pipes, a plurality of heat-dissipating fins and a plurality of fixing elements. The metallic base has a first plate and a second plate overlapped with each other. The first plate and the second plate are provided with a plurality of locking holes corresponding to the fixing holes. The vapor chamber is brought into thermal contact with the first plate. The heat pipes penetrate between the first plate and the second plate. The heat-dissipating fins are sheathed on the heat pipes and parallel to each other. The fixing elements penetrate the fixing holes and the locking holes to thereby fix the lamp seat to the first plate and the second plate.

In comparison with prior art, the present invention has advantages features as follows:

According to the present invention, since the metallic base abuts against an outer surface of the vapor chamber and the fixing elements are used to combine the lamp seat and the metallic base to thereby sandwich the vapor chamber between the lamp seat and the metallic base, providing holes or tabs on the edge of the vapor chamber is omitted, so that the working hours for manufacturing the vapor chamber is reduced. Furthermore, when the vapor chamber is to be connected with other heat-dissipating body, the connecting position of the heat-dissipating body will not be restricted by the profile of the vapor chamber, which enhances the practicability and convenience of the present invention.

### BRIEF DESCRIPTION OF DRAWING

FIG. 1 is a perspective view showing a LED lamp and a heat-dissipating assembly thereof according to the present invention;

FIG. 2 is an exploded perspective view showing the LED lamp of the present invention;

FIG. 3 is an exploded perspective view showing the heat-dissipating assembly of the present invention;

FIG. 4 is an assembled perspective view showing the LED lamp and the heat-dissipating assembly of the present invention;

FIG. 5 is an assembled cross-sectional view showing the LED lamp and the heat-dissipating assembly of the present invention; and

FIG. 6 is an assembled cross-sectional view showing the LED lamp and the heat-dissipating assembly of the present invention from another viewing angle.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

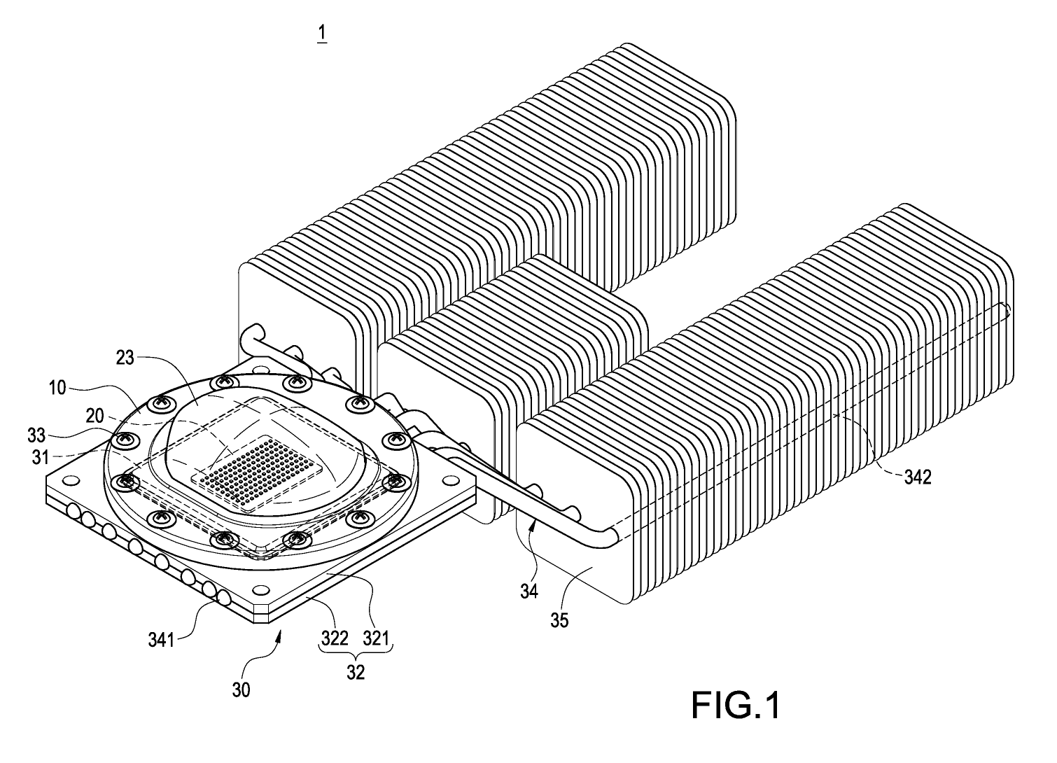

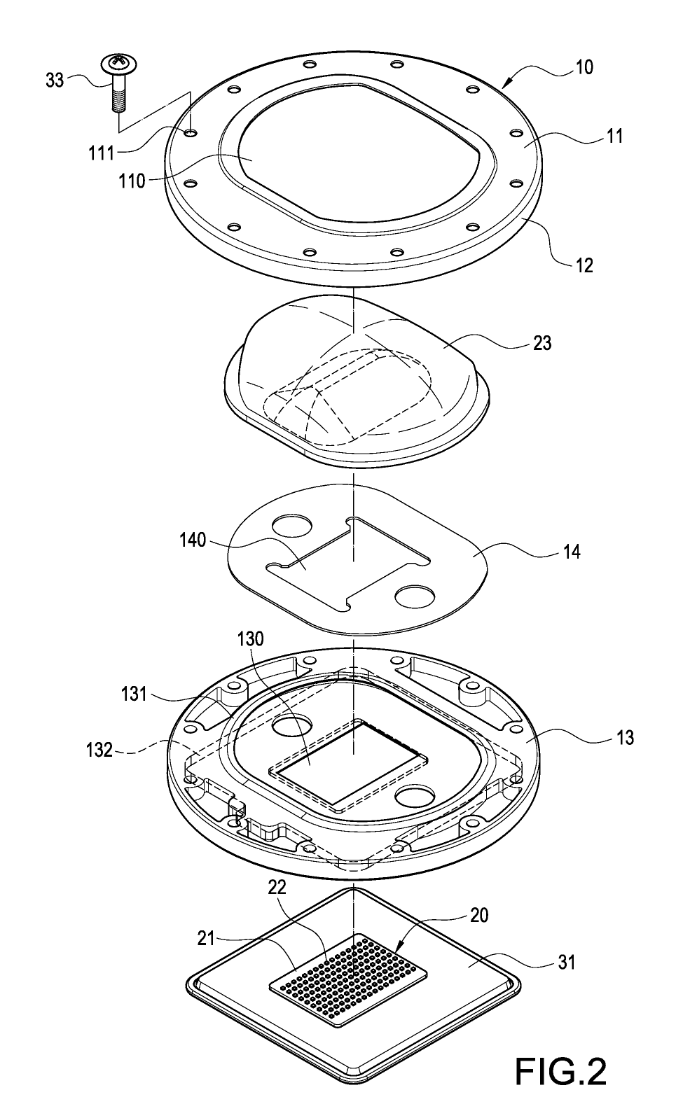

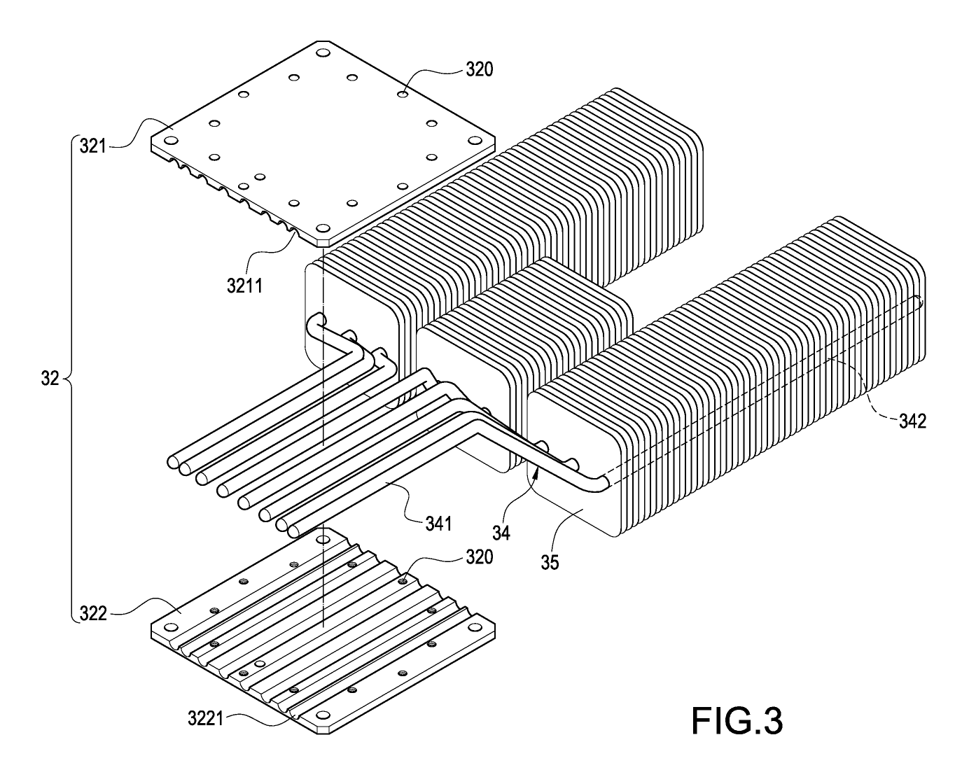

Please refer to FIGS. 1 to 3. FIG. 1 is a perspective view showing a LED lamp and a heat-dissipating assembly thereof according to the present invention, FIG. 2 is an exploded perspective view showing the LED lamp of the present invention, and FIG. 3 is an exploded perspective view showing the heat-dissipating assembly of the present invention. The LED lamp 1 of the present invention has a lamp seat 10, a LED module 20 mounted on the lamp seat 10, and a heat-dissipating assembly 30.

The heat-dissipating assembly 30 includes a vapor chamber 31, a metallic base 32, a plurality of fixing elements 33, a plurality of heat pipes 34 and a plurality of heat-dissipating fins 35. The metallic base 32 comprises a first plate 321 and a second plate 322 overlapped with each other. The first plate 321 is provided with a plurality of first grooves 3211 and the second plate 322 is provided with a plurality of second grooves 3221. The first plate 321 and the second plate 322 are provided with locking holes 320 corresponding to each other.

The interior of the vapor chamber 31 is filled with a working fluid and a wick structure. Since the working fluid and the wick structure are conventional and not the characteristics of the present invention, the description thereof is omitted for simplicity. The vapor chamber 31 is brought into thermal contact with the first plate 321.

The heat pipes 34 are fixed in the first grooves 3211 and the second grooves 3221 respectively. Each of the heat pipes 34 has a heat-absorbing section 341 and a heat-releasing section 342 extending from the heat-absorbing section 341. The heat-absorbing section 341 is fixed in the first groove 3211 and the second groove 3221. The heat-releasing section 342 protrudes from the end surfaces of the first plate 321 and the second plate 322. In the present embodiment, the pitch of the heat-releasing sections 342 of the heat pipes 34 is larger than that of the heat-absorbing sections 341. That is, the heat-releasing sections 342 are laterally bent from the end surfaces of the first plate 321 and the second plate 322 to enlarge the pitch of the heat-releasing sections 342.

The heat-dissipating fins 35 are sheathed on the heat-releasing sections 342 of the heat pipes 34 and parallel to each other. The heat-dissipating fins 35 are connected in series outside the end surfaces of the first plate 321 and the second plate 322.

The lamp seat 10 has a bottom plate 11 and a surrounding plate 12 vertically extending from the periphery of the bottom plate 11. The bottom plate 11 is provided with an opening 110 and a plurality of fixing holes 111 surrounding the opening 110. The LED module 20 is positioned to correspond to the opening 110 and comprises a circuit board 21 abutting against the vapor chamber 31, a plurality of LEDs 22 disposed on one surface of the circuit board 21, and a transparent lens 23. The transparent lens 23 is disposed outside the LEDs 22 to cover the opening 110.

The lamp seat 10 further has a sealing pad 13 and a pressing plate 14. The sealing pad 13 abuts against the inner surface of the lamp seat 10 and covers the transparent lens 13. The lamp seat 10 is provided with a penetration 130 corresponding to the LEDs 22. The pressing plate 14 is sandwiched between the sealing pad 13 and the transparent lens 23. The pressing plate 14 is provided with a through-hole 140 corresponding to the LEDs 22. Further, two opposite surfaces of the sealing pad 13 are provided with a skirt portion 131 and an accommodating space 132 respectively.

The fixing elements 33 penetrate the fixing holes 111 and the locking holes 320 to fix the lamp seat 10 to the first plate 321 and the second plate 322.

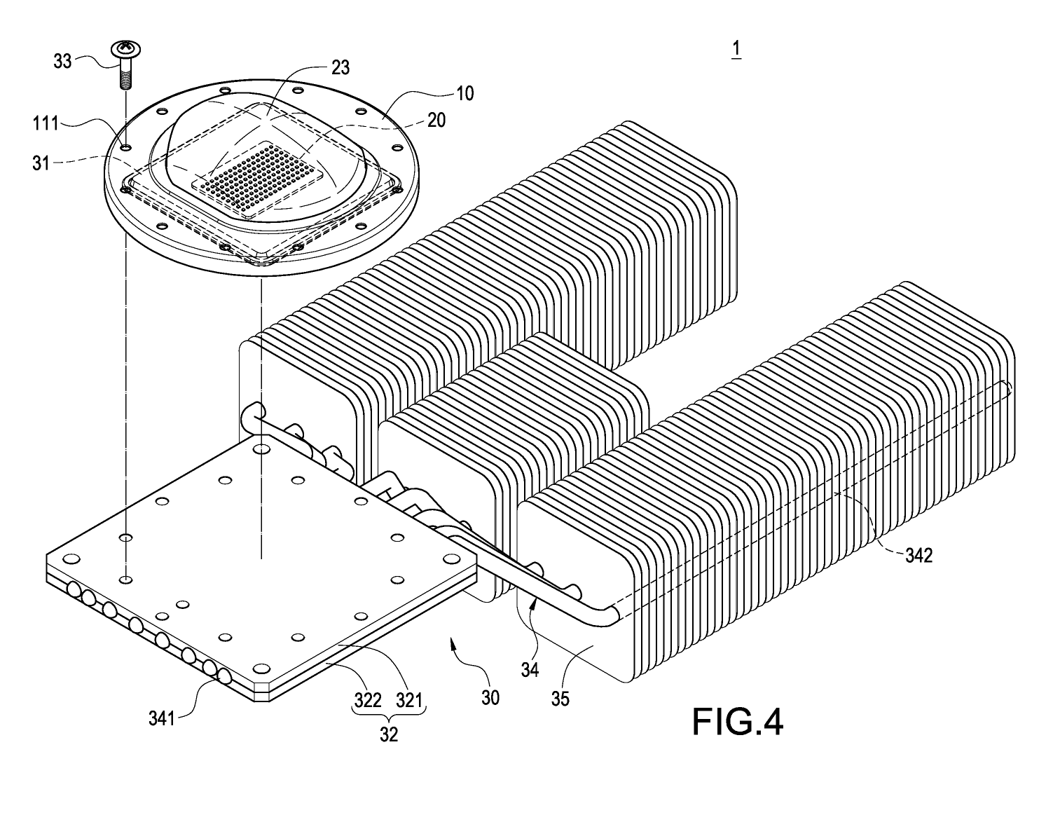

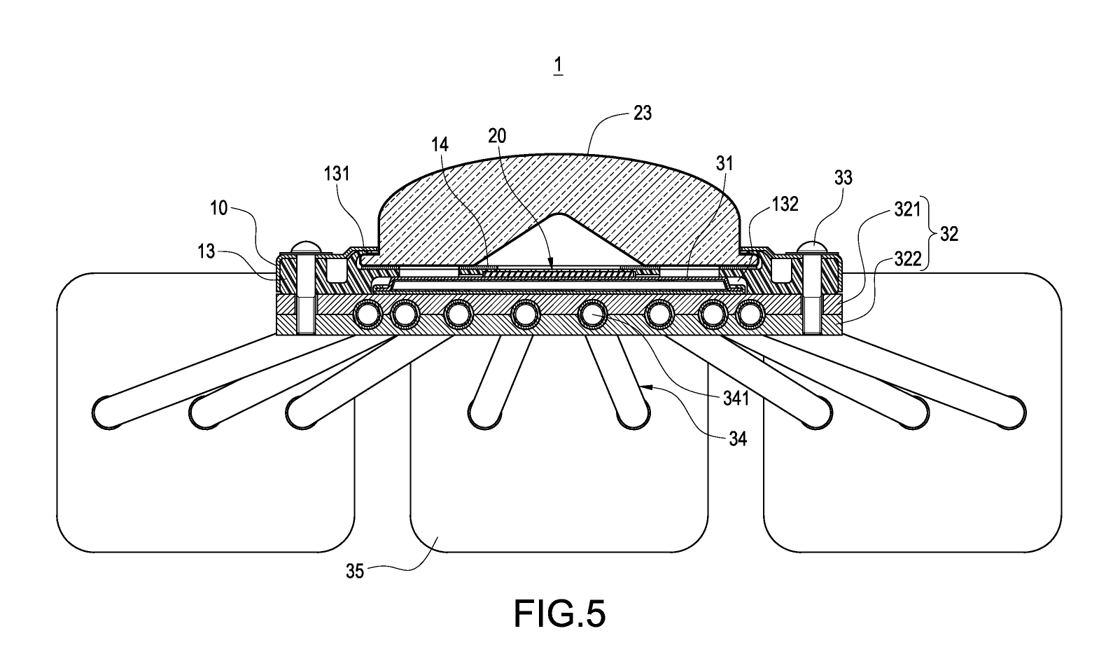

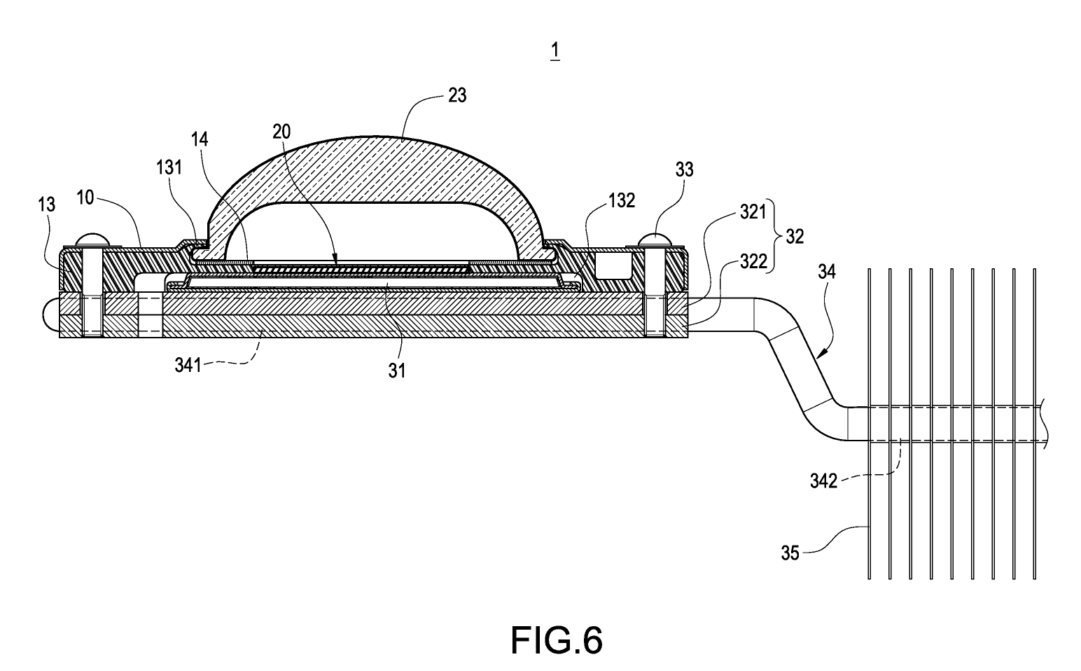

Please refer to FIGS. 4 to 6. FIG. 4 is an assembled perspective view showing the LED lamp and the heat-dissipating assembly of the present invention, FIG. 5 is an assembled cross-sectional view showing the LED lamp and the heat-dissipating assembly of the present invention, and FIG. 6 is an assembled cross-sectional view showing the LED lamp and the heat-dissipating assembly of the present invention from another viewing angle. In assembly, the edges of the transparent lens 23 and the pressing plate 10 are disposed under the skirt portion 131 of the sealing pad 13 to prevent external objects from entering the lamp seat 10 through the gaps between the lamp seat 10 and the transparent lens 23. With this arrangement, the LED module 20 and the vapor chamber 31 can be disposed in the accommodating space 132. Next, the fixing elements 33 penetrate the fixing holes 111 of the lamp seat 10 and the locking holes 320 of the metallic seats 32 (including the first plate 321 and the second plate 322), thereby fixing the lamp seat 10 to the metallic base 32. It can be seen from the drawings that, the LED module 20 and the vapor chamber 31 are sandwiched between the transparent lens 23 and the metallic base 32. The pressing plate 14 presses the circuit board 21 of the LED module 20, so that the LED module 20 can be tightly connected to the vapor chamber 31. On the other hand, the vapor chamber 31 is brought into thermal contact with the first plate 321 tightly.

With this arrangement, the waste heat generated by the LED module 20 can be conducted to the metallic base 32 through the vapor chamber 31. Then, the metallic base 32 conducts the heat to the heat pipes 34 therein. Finally, the heat pipes 34 rapidly conduct the heat to the heat-dissipating fins 35. Since the heat-dissipating fins 35 have a large heat-dissipating area, the waste heat can be dissipated to the outside vary quickly, thereby lowering the temperature of the LED module 20 and increasing the heat-dissipating efficiency of the whole assembly.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A LED lamp, including:
a metallic base having a first plate and a second plate overlapped with each other, the first plate and the second plate being provided with a plurality of locking holes corresponding to each other;
a vapor chamber brought into thermal contact with the first plate;
a plurality of heat pipes penetrating between the first plate and the second plate;
a plurality of heat-dissipating fins sheathed on the heat pipes and parallel to each other;
a lamp seat provided with an opening and fixing holes corresponding to the locking holes;
a LED module positioned to correspond to the opening, the LED module comprising a circuit board abutting the vapor chamber and a plurality of LEDs arranged on one surface of the circuit board; and
a plurality of fixing elements penetrating the fixing holes and the locking holes to thereby fix the lamp seat to the first plate and the second plate.

2. The LED lamp according to claim 1, wherein the first plate is provided with a plurality of first grooves, the second plate is provided with a plurality of second grooves, the heat pipes are fixed in the first grooves and the second grooves respectively.

3. The LED lamp according to claim 2, wherein each of the heat pipes has a heat-absorbing section and a heat-releasing section, the heat-absorbing section is fixed in the first groove and the second groove, and the heat-releasing section protrudes from end surfaces of the first plate and the second plate.

4. The LED lamp according to claim 3, wherein the pitch of the heat-releasing sections of the heat pipes is larger than that of the heat-absorbing sections.

5. The LED lamp according to claim 3, wherein the heat-dissipating fins are connected in series outside the end surfaces of the first plate and the second plate.

6. The LED lamp according to claim 1, wherein the fixing holes surround the outside of the opening.

7. The LED lamp according to claim 1, wherein the LED module further includes a transparent lens disposed outside the LEDs to cover the opening.

8. The LED lamp according to claim 7, further including a sealing pad abutting against an inner wall of the lamp seat and covering the transparent lens, the sealing pad being provided with a perforation corresponding to the LEDs.

9. The LED lamp according to claim 8, further including a pressing plate sandwiched between the sealing pad and the transparent lens, the pressing plate being provided with a through-hole corresponding to the LEDs.

10. A heat-dissipating assembly of a LED lamp, the LED lamp comprising a lamp seat having a plurality of fixing holes, the heat-dissipating assembly including:
a metallic base having a first plate and a second plate overlapped with each other, the first plate and the second plate being provided with a plurality of locking holes corresponding to the fixing holes;
a vapor chamber brought into thermal contact with the first plate;
a plurality of heat pipes penetrating between the first plate and the second plate;
a plurality of heat-dissipating fins sheathed on the heat pipes and parallel to each other; and
a plurality of fixing elements penetrating the fixing holes and the locking holes to thereby fix the lamp seat to the first plate and the second plate.

11. The heat-dissipating assembly of a LED lamp according to claim 10, wherein the first plate is provided with a plurality of first grooves, the second plate is provided with a plurality of second grooves, the heat pipes are fixed in the first grooves and the second grooves respectively.

12. The heat-dissipating assembly of a LED lamp according to claim 11, wherein each of the heat pipes has a heat-absorbing section and a heat-releasing section, the heat-absorbing section is fixed in the first groove and the second groove, and the heat-releasing section protrudes from the end surfaces of the first plate and the second plate.

13. The heat-dissipating assembly of a LED lamp according to claim 12, wherein the pitch of the heat-releasing sections of the heat pipes is larger than that of the heat-absorbing sections.

14. The heat-dissipating assembly of a LED lamp according to claim 12, wherein the heat-dissipating fins are connected in series outside the end surfaces of the first plate and the second plate.
